(19) United States
(12) Patent Application Publication
(10) Pub. No.: US 2010/0229993 A1
(43) Pub. Date: Sep. 16, 2010

(54) REINFORCEMENT FOR EXHAUST SYSTEM CONNECTION INTERFACE

(76) Inventor: Kwin Abram, Columbus, IN (US)

Correspondence Address: PAMELA A. KACHUR, 577 W Santee Drive, Greensburg, IN, 47240, US

(21) Appl. No.: 12/688,931

(22) Filed: Jan. 18, 2010

Related U.S. Application Data
(60) Provisional application No. 61/159,225, filed on Mar. 11, 2009.

(51) Int. Cl. F16L 9/18; B21D 51/16; B23K 13/01

(52) U.S. Cl. 138/114; 29/890.08; 219/607; 138/155

(57) ABSTRACT

A vehicle exhaust system includes first and second exhaust components that are attached to each other at a connection interface. A reinforcement member is positioned in an overlapping relationship with each of the first and second exhaust components, and is secured in place to strengthen the connection interface.

### RELATED APPLICATION

This application claims priority to U.S. Provisional Application No. 61/159,225, which was filed Mar. 11, 2009.

### TECHNICAL FIELD

This invention generally relates to a reinforcement member that is used at connection interfaces within a vehicle exhaust system.

### BACKGROUND OF THE INVENTION

An exhaust system is comprised of several types of components such as converters, mufflers, resonators, etc. that are connected to each other to define an exhaust gas pathway. Each of these components are positioned downstream of a vehicle engine and upstream of an exhaust gas outlet to atmosphere. A series of exhaust pipes or exhaust tubes are used to connect these components to each other to form the exhaust gas pathway. Also, due to packaging constraints within a specified vehicle, a series of exhaust pipes may be connected to each other as well as to an exhaust component in order to direct exhaust gas flow between the various exhaust components.

When exhaust pipes are attached to each other, there is a connection interface between the connecting pipes. Further, when an exhaust pipe is attached to an exhaust component, there is also a connection interface between the pipe and the component. These connection interfaces are some of the most highly stressed points in the exhaust system. Additionally, these connection interfaces often comprise welded connection interfaces. Welding is a highly variable process that can further weaken the components at this critical location.

### SUMMARY OF THE INVENTION

A vehicle exhaust system includes first and second exhaust components that are attached to each other at a connection interface. A reinforcement member is positioned in an overlapping relationship with each of the first and second exhaust components, and is secured in place to strengthen the connection interface.

The first and second exhaust components could comprise any combination of exhaust pipes, mufflers, filters, resonators, convertors, etc. for example.

In one example, the second exhaust component has a first end and a second end, with the first end being surrounded by the first exhaust component. A first connection interface is formed between the first exhaust component and at least one of the reinforcement member and the second exhaust component, and a second connection interface is formed between the reinforcement member and at least one of the first and the second exhaust components.

In one example, the first connection interface comprises a first weld and the second connection interface comprises one of welding, brazing, or sizing.

In one example, the second connection interface is at one end of the reinforcement member. A third connection interface is formed between an opposite end of the reinforcement member and the second exhaust component.

In one example, the reinforcement member comprises a rigid sleeve. The rigid sleeve is positioned radially inwardly of the first exhaust component and radially outwardly of the second exhaust component. Optionally, the rigid sleeve is positioned radially inwardly of the first exhaust component and the second exhaust component.

In one example, the rigid sleeve is attached to one of the exhaust components to form a sub-assembly that is subsequently attached to the other exhaust component. The sub-assembly can be attached to the exhaust component using any of various methods.

These and other features of the present invention can be best understood from the following specification and drawings, the following of which is a brief description.

### BRIEF DESCRIPTION OF THE DRAWINGS

FIG. 1 is a schematic representation of one example of a vehicle exhaust system with multiple connection interfaces.

FIG. 2 shows one example of a connection interface between a reinforcement member and an exhaust pipe as used in a connection between two exhaust pipes.

In FIG. 3 is similar to FIG. 2 but shows a reinforcement member being used for a connection between an exhaust component and an exhaust pipe.

FIG. 4 is similar to FIG. 2 but shows another example of a connection interface between the reinforcement member and the exhaust pipe.

FIG. 5 is similar to FIG. 3 but shows another example of a connection interface between the reinforcement member and the exhaust pipe.

FIG. 6 is similar to FIG. 2 but shows another example of a connection interface between the reinforcement member and the exhaust pipe.

FIG. 7 is similar to FIG. 3 but shows another example of a connection interface between the reinforcement member and the exhaust pipe.

FIG. 8 is similar to FIG. 2 but shows another example of a connection interface between the reinforcement member and the exhaust pipe.

FIG. 9 is similar to FIG. 3 but shows another example of a connection interface between the reinforcement member and the exhaust pipe.

FIG. 10 shows a schematic upper half view of an alternate mounting location for a reinforcement member used at a connection interface between two exhaust pipes, and also shows one example of a connection between the reinforcement member and one of the exhaust pipes.

FIG. 11 is similar to FIG. 10 but shows another example of a connection between the reinforcement member and exhaust pipe.

FIG. 12 is similar to FIG. 10 but shows another example of a connection between the reinforcement member and exhaust pipe.

FIG. 13 is similar to FIG. 10 but shows another example of a connection between the reinforcement member and exhaust pipe.

FIG. 14 shows a schematic upper half view of an alternate mounting location for a reinforcement member used at a connection interface between an exhaust pipes and an exhaust component, and also shows one example of a connection between the reinforcement member and the exhaust pipe.

FIG. 15 is similar to FIG. 14 but shows another example of a connection between the reinforcement member and exhaust pipe.

FIG. 16 is similar to FIG. 14 but shows another example of a connection between the reinforcement member and exhaust pipe.

FIG. 17 is similar to FIG. 14 but shows another example of a connection between the reinforcement member and exhaust pipe.

FIG. 18 shows a schematic upper half view of another example of a reinforcement member used at a connection interface between two exhaust pipes, and also shows one example of a connection between the reinforcement member and one of the exhaust pipes.

FIG. 19 is similar to FIG. 18 but shows another example of a connection between the reinforcement member and exhaust pipe.

FIG. 20 is similar to FIG. 18 but shows another example of a connection between the reinforcement member and exhaust pipe.

FIG. 21 is similar to FIG. 18 but shows another example of a connection between the reinforcement member and exhaust pipe.

FIG. 22 shows a schematic upper half view of another example of a reinforcement member used at a connection interface between an exhaust pipe and an exhaust component, and also shows one example of a connection between the reinforcement member and at least one of the exhaust component and exhaust pipe.

FIG. 23 is similar to FIG. 22 but shows another example of a connection interface for the reinforcement member.

FIG. 24 is similar to FIG. 22 but shows another example of a connection interface for the reinforcement member.

FIG. 25 is similar to FIG. 22 but shows another example of a connection interface for the reinforcement member.

FIG. 26 shows a schematic upper half view of another example of a reinforcement member used at a connection interface between an exhaust pipe and an exhaust component which can be used with any of the connection interfaces for the reinforcement member as described in FIGS. 22-25.

FIG. 27 is similar to FIG. 2 but shows an additional connection interface between the reinforcement member and one of the exhaust pipes.

FIG. 28 is similar to FIG. 3 but also includes the additional connection interface.

FIG. 29 is similar to FIG. 6 but also includes the additional connection interface.

FIG. 30 is similar to FIG. 7 but also includes the additional connection interface.

FIG. 31 is similar to FIG. 10 but also includes the additional connection interface.

FIG. 32 is similar to FIG. 12 but also includes the additional connection interface.

FIG. 33 is similar to FIG. 14 but also includes the additional connection interface.

FIG. 34 is similar to FIG. 16 but also includes the additional connection interface.

FIG. 35 is similar to FIG. 18 but also includes the additional connection interface.

FIG. 36 is similar to FIG. 20 but also includes the additional connection interface.

FIG. 37 is similar to FIG. 22 but also includes the additional connection interface.

FIG. 38 is similar to FIG. 24 but also includes the additional connection interface.

### DETAILED DESCRIPTION OF THE PREFERRED EMBODIMENT

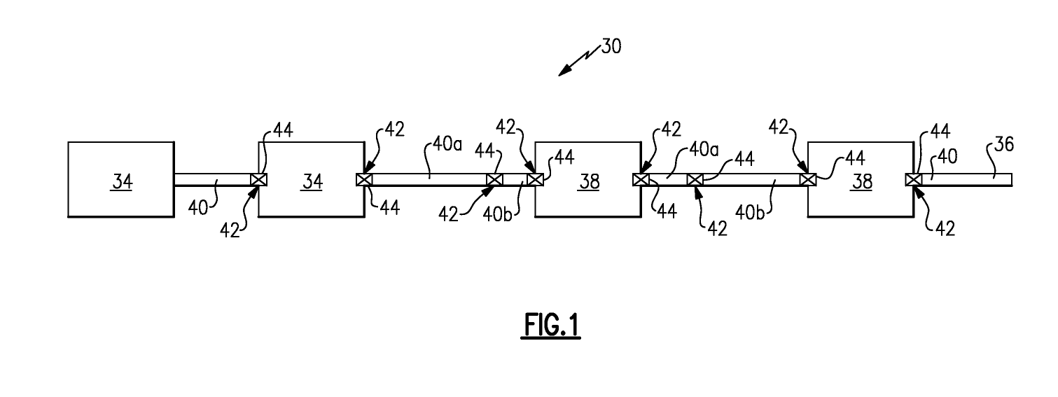

A vehicle exhaust system 30, shown in FIG. 1, directs heated exhaust gases from an engine 34 to an outlet 36, which can comprise a tailpipe for example, which leads to an external atmosphere. Various exhaust components 38 can be utilized within the exhaust system 30, such as filters, traps, converters, resonators, mufflers, etc. A series of exhaust pipes 40 are used to connect the exhaust components 38 together. A single pipe 40 can be used to connect two adjacent exhaust components 38 together, or multiple pipes 40a, 40b can be connected to each other in order to connect adjacent exhaust components 38 together.

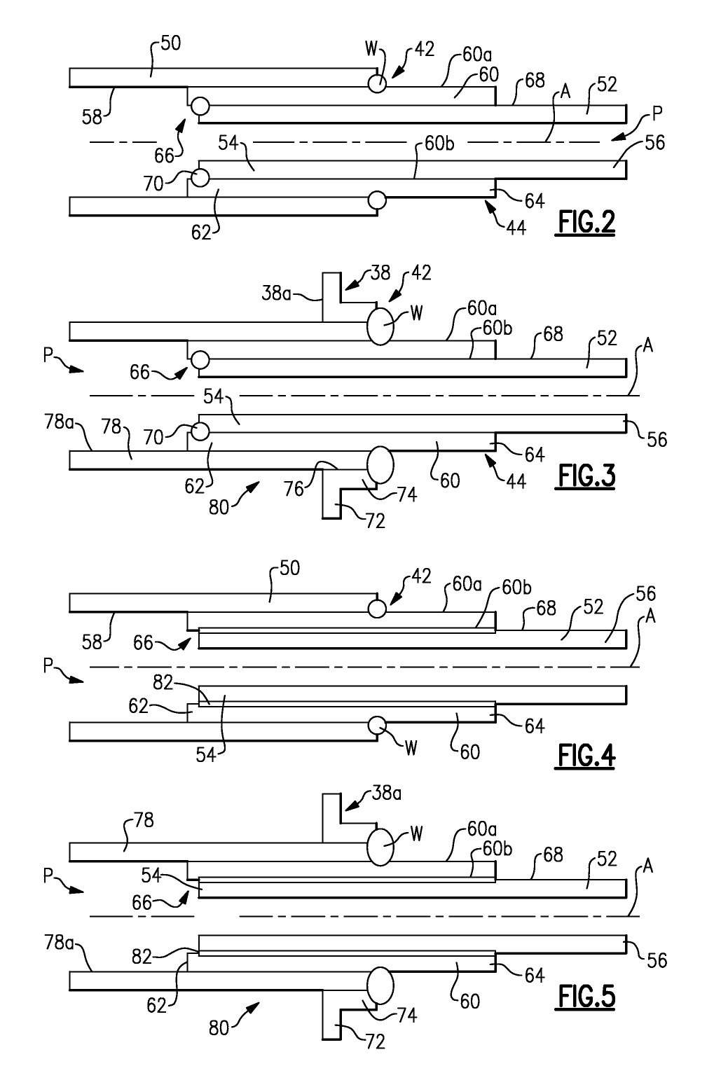

When two pipes 40 are connected to each other, or when one pipe end is connected to an exhaust component 38, there is a connection interface 42 between the adjoining structures. These connection interfaces 42 are subjected to high stress levels within the exhaust system 30. In order to make these connection interfaces 42 more robust, a reinforcement member 44 (schematically shown in FIG. 1) is utilized at the connection interfaces 42. Examples of the reinforcement member 44 are shown in FIGS. 2-38.

FIG. 2 shows an example with a first exhaust pipe 50 and a second exhaust pipe 52. The second exhaust pipe 52 extends between a first pipe end 54 and a second pipe end 56 and defines an exhaust gas passage P. The first exhaust pipe 50 extends between a first pipe end 46 and a second pipe end 48 to define a central opening that forms another portion of the exhaust gas passage P when connected to the second exhaust pipe 52.

In this example, the first pipe end 54 of the second exhaust pipe 52 is inserted within the central opening defined by the first exhaust pipe 50. The central opening of the first exhaust pipe 50 is defined by an inner surface 58 that surrounds an outer surface 68 of the second exhaust pipe 52.

In this example, the reinforcement member 44 comprises a rigid sleeve 60 having a first sleeve end 62 and a second sleeve end 64. The rigid sleeve 60 includes an outer surface 60a and an inner surface 60b. The rigid sleeve 60 is secured to the first pipe end 54 of the second exhaust pipe 52 at a sleeve connection interface 66. The rigid sleeve 60 and the second exhaust pipe 52 are then secured to the first exhaust pipe 50 at the connection interface 42. This connection interface 42 comprises a weld W. The incorporation of the rigid sleeve 60 at connecting joint interfaces 42 significantly reduces stress levels at these connection interfaces 42.

In one example, the rigid sleeve 60 is attached to the second exhaust pipe 52 to form a sub-assembly that is subsequently attached to the first exhaust pipe 50. This order of assembly steps can be utilized in any of the examples set forth below.

FIG. 2 shows an example where the rigid sleeve 60 is supported on the outer surface 68 of the second exhaust pipe 52. Thus, the rigid sleeve 60 surrounds the first pipe end 54 of the second exhaust pipe 52 and is in turn surrounded by the first exhaust pipe 50, which results in the rigid sleeve 60 being positioned radially between the first 50 and second 52 exhaust pipes. This type of configuration, i.e. the rigid sleeve 60 being external to the second exhaust pipe 52, is shown in FIGS. 2-9.

In FIG. 2, the outer surface 60a of the rigid sleeve 60 is in direct abutting engagement with the inner surface 58 of the first exhaust pipe 50. Further, the inner surface 60b of the rigid sleeve 60 is in direct abutting engagement with the outer surface 68 of the second exhaust pipe 52.

FIG. 2 shows an example where the rigid sleeve 60 is secured to the second exhaust pipe 52 at the sleeve connection interface 66, which comprises a simple weld 70 at associated end faces of the rigid sleeve 60 and second exhaust pipe 52. In this example, the end faces of the rigid sleeve 60 and the second exhaust pipe 52 are axially offset from each other along a central axis A defined by the first 50 and second 52 exhaust pipes.

In FIG. 3, the first exhaust pipe 50 is replaced by an exhaust component 38 that comprises a muffler 38a, for example. The muffler 38a includes an outer shell portion 72 with a mounting boss 74 having an opening 76. The muffler 38a also includes at least one internal pipe portion 78 that extends inwardly from the opening 76 into an internal cavity 80 that is defined by the outer shell portion 72. The connection interface 42 between the muffler 38a and the second exhaust pipe 52 comprises a weld W that is positioned at an interface between the rigid sleeve 60, the mounting boss 74, and an end face of the internal pipe portion 78.

In FIG. 3, the outer surface 60a of the rigid sleeve 60 is in direct abutting engagement with an inner surface 78a of the internal pipe portion 78 of the muffler 38a. The inner surface 60b of the rigid sleeve 60 is in direct abutting engagement with the outer surface 68 of the second exhaust pipe 52. The rigid sleeve 60 is secured to the second exhaust pipe 52 at the sleeve connection interface 66 with the same type of weld 70 as shown in FIG. 2.

FIG. 4 is similar to FIG. 2, but at the sleeve connection interface 66 the rigid sleeve 60 is brazed to the outer surface 68 of the second exhaust pipe 52 as indicated at 82.

FIG. 5 is similar to FIG. 3, but at the sleeve connection interface 66 the rigid sleeve 60 is secured to the second exhaust pipe 52 with brazing 82 similar to that shown in FIG. 4.

FIG. 6 is similar to FIG. 2, but at the sleeve connection interface 66 the inner surface 60b of the rigid sleeve 60 is resistance welded, or spot welded, to the outer surface 68 of the second exhaust pipe 52 as indicated at 84.

FIG. 7 is similar to FIG. 3, but at the sleeve connection interface 66 the inner surface 60b of the rigid sleeve 60 is secured to the outer surface 68 of the second exhaust pipe 52 with a resistance weld 84 similar to that shown in FIG. 6.

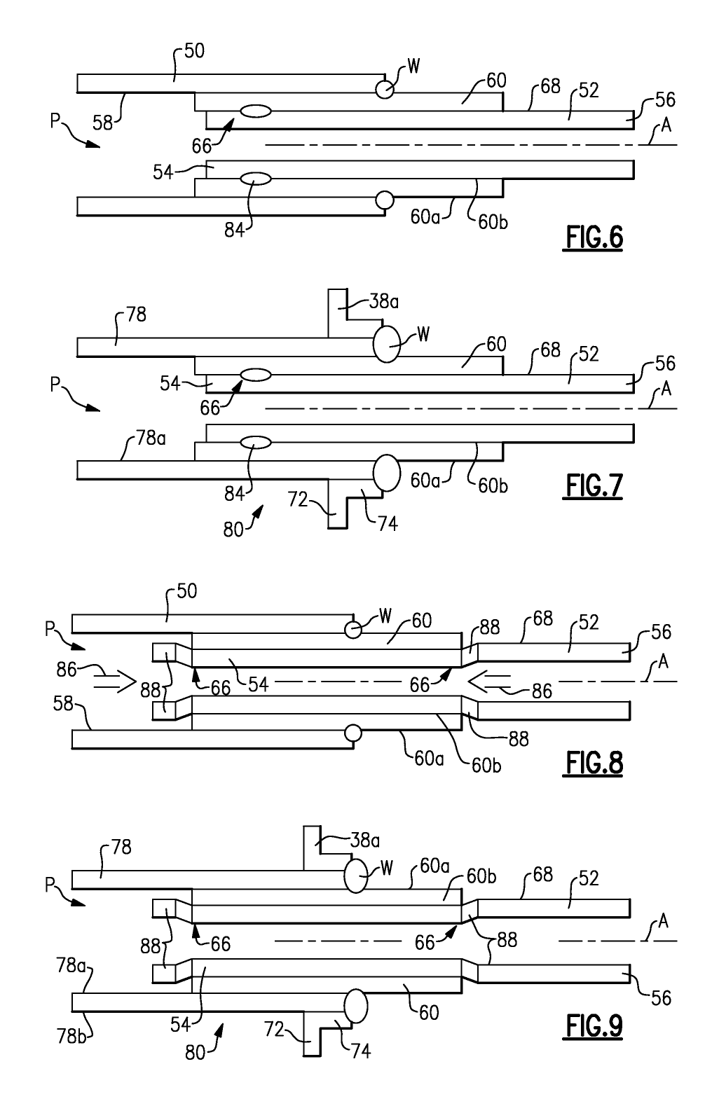

FIG. 8 is similar to FIG. 2, but at the sleeve connection interface 66 the rigid sleeve 60 is attached to the second exhaust pipe 52 with a sizing operation as indicated at 86. In the sizing operation 86, portions 88 of the second exhaust pipe 52 are subjected to a sizing step such that the portions 88 are plastically/permanently deformed outwardly relative to the central axis A to lock the second exhaust pipe 52 to the rigid sleeve 60. The portions 88 of the second exhaust pipe 52 are located at each axial end of the rigid sleeve such that the second exhaust pipe 52 is attached to the rigid sleeve 60 at two separate locations.

FIG. 9 is similar to FIG. 3, but at the sleeve connection interface 66 the rigid sleeve 60 and the second exhaust pipe 52 are locked together via sized portions 88 of the second exhaust pipe 52 similar to that shown in FIG. 8.

FIGS. 10-17 show configurations (only an upper half of the exhaust pipes and/or exhaust component is shown) where instead of being external to the second exhaust pipe 52, the rigid sleeve 60 is internal to the second exhaust pipe 52, such that the second exhaust pipe 52 is positioned radially between the second exhaust pipe 52 and the first exhaust pipe 50 or muffler 38a. The outer surface 60a of the rigid sleeve 60 is in direct abutting engagement with an inner surface 92 of the second exhaust pipe 52. This type of configuration eliminates a potential leak path that could occur with the external configuration of the rigid sleeve 60.

FIG. 10 shows an example where the rigid sleeve 60 is welded to the second exhaust pipe 52 with a simple weld 70 similar to that shown in FIG. 2.

FIG. 11 shows an example where the rigid sleeve 60 is brazed at 82 to the inner surface 92 of the second exhaust pipe 52 in a manner similar to that of FIG. 4.

FIG. 12 shows an example where the outer surface 60a of the rigid sleeve 60 is resistance or spot welded to the inner surface 92 of the second exhaust pipe 52, as indicated at 84, in manner similar to that of FIG. 6.

FIG. 13 shows an example where the rigid sleeve 60 is attached to the second exhaust pipe 52 with a sizing operation, indicated at 86, that is similar to that shown in FIG. 8. In this example, portions 88 of the second exhaust pipe 52 are subjected to a sizing step such that the portions 88 are plastically/permanently deformed inwardly toward the central axis to lock the second exhaust pipe 52 to the rigid sleeve 60. The portions 88 are located at each end of the rigid sleeve 60 as shown.

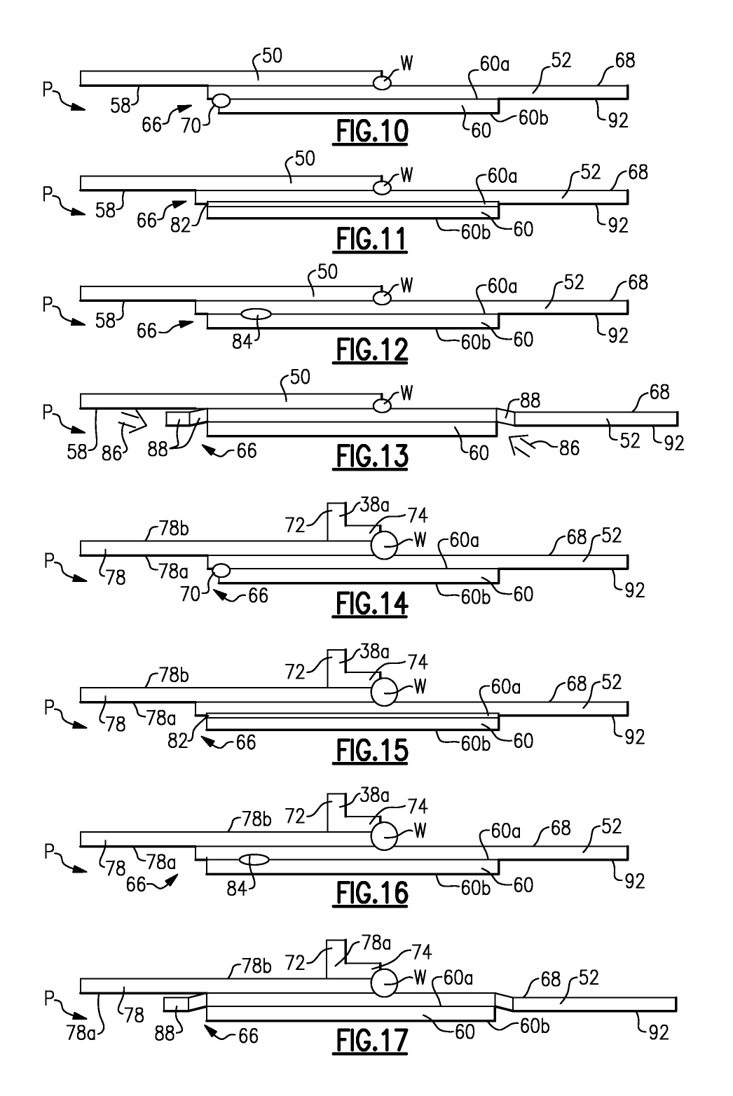

FIGS. 14-17 show a configuration with a muffler 38a such as that shown in FIGS. 3, 5, 7, and 9, but which have an internally mounted rigid sleeve 60 similar to that shown in FIGS. 10-13. In this configuration, an outer surface 78b of the internal pipe portion 78 abuts directly against the mounting boss portion 74 of the muffler 38a, and the outer surface 68 of the second exhaust pipe 52 directly abuts against the inner surface 78a of the internal pipe portion 78. The outer surface 60a of the rigid sleeve 60 abuts directly against the inner surface 92 of the second exhaust pipe 52.

FIG. 14 shows a weld 70 between the second exhaust pipe 52 and rigid sleeve 60 similar to that of FIG. 10.

FIG. 15 shows brazing 82 between the second exhaust pipe 52 and rigid sleeve 60 similar to that of FIG. 11.

FIG. 16 shows a resistance or spot weld 84 between the second exhaust pipe 52 and rigid sleeve 60 similar to that of FIG. 12.

FIG. 17 shows sized portion 88 that lock the second exhaust pipe 52 to the rigid sleeve 60 in a manner similar to that shown in FIG. 13.

FIGS. 18-21 show a configuration (only an upper half of the exhaust pipes is shown) where associated end faces of the first 50 and second 52 exhaust pipes are butt-welded to each other as indicated at 90. The rigid sleeve 60 is then mounted radially inwardly of both the first 50 and second 52 exhaust pipes. The outer surface 60a of the rigid sleeve 60 is in direct abutting engagement with the inner surface 58 of the first exhaust pipe 50 and the inner surface 92 of the second exhaust pipe 52.

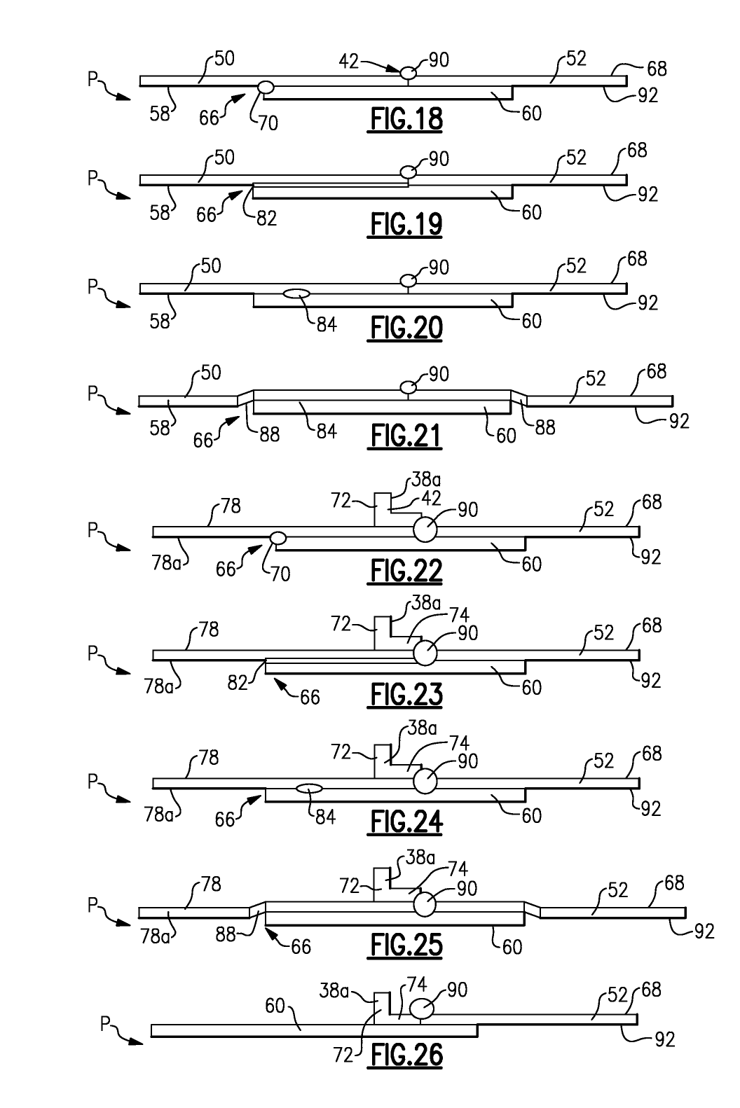

The rigid sleeve 60 is secured to one of the exhaust pipes 50, 52 by one of welding 70 (FIG. 18), brazing 82 (FIG. 19), resistance welding (FIG. 20), or sizing 86 (FIG. 21) in the manners described above. In the example shown in FIG. 21, each of the first 50 and second 52 exhaust pipes include a portion 88 that is subjected to the sizing operation such that each of the first 50 and second 52 is locked to the rigid sleeve 60.

FIGS. 22-26 show a configuration with a muffler 38a such as that shown in FIGS. 3, 5, 7, and 9, but which are similar to FIGS. 18-21. In these examples, an end face of the internal pipe portion 78 of the muffler 38a is butt-welded to the end face of the second exhaust pipe 52. The rigid sleeve 60 is then mounted radially inwardly of both the internal pipe portion 78 of the muffler 38a and the second exhaust pipe 52. The outer surface 60a of the rigid sleeve 60 is in direct abutting engagement with the inner surface 78a of the internal pipe portion 78 and the inner surface 92 of the second exhaust pipe 52.

The rigid sleeve 60 is secured in place by one of welding 70 (FIG. 22), brazing 82 (FIG. 23), resistance welding (FIG. 24), or sizing 86 (FIG. 25) in the manners described above. In the example shown in FIG. 25, each of the internal pipe portion 78 and second exhaust pipe 52 includes a portion 88 that is subjected to the sizing operation such that the internal pipe portion 78 and second exhaust pipe 52 are both locked to respective ends the rigid sleeve 60.

FIG. 26 shows an example where the end face of the second exhaust pipe 52 is butt-welded to an end face of the mounting boss portion 74 of the outer shell 72 of the muffler 38a. The rigid sleeve 60 is then secured to internal surfaces of the muffler 38a and the second exhaust component 52. Any of the described attachment methods could then be used to secure the rigid sleeve 60 in place.

FIGS. 27-38 show different examples where opposing ends of the rigid sleeve 60 are both attached to an exhaust pipe and/or exhaust component, i.e. the rigid sleeve 60 includes an additional connection interface. FIG. 27 is similar to FIG. 2 with the addition of a second weld W2 between an outer end of the rigid sleeve 60 and the second exhaust pipe 52. Any type of welding method can be used for the second weld W2, such as a resistance weld or spot weld, for example. The use of welds W, W2 at both ends of the rigid sleeve 60 significantly improves the robustness of the connection.

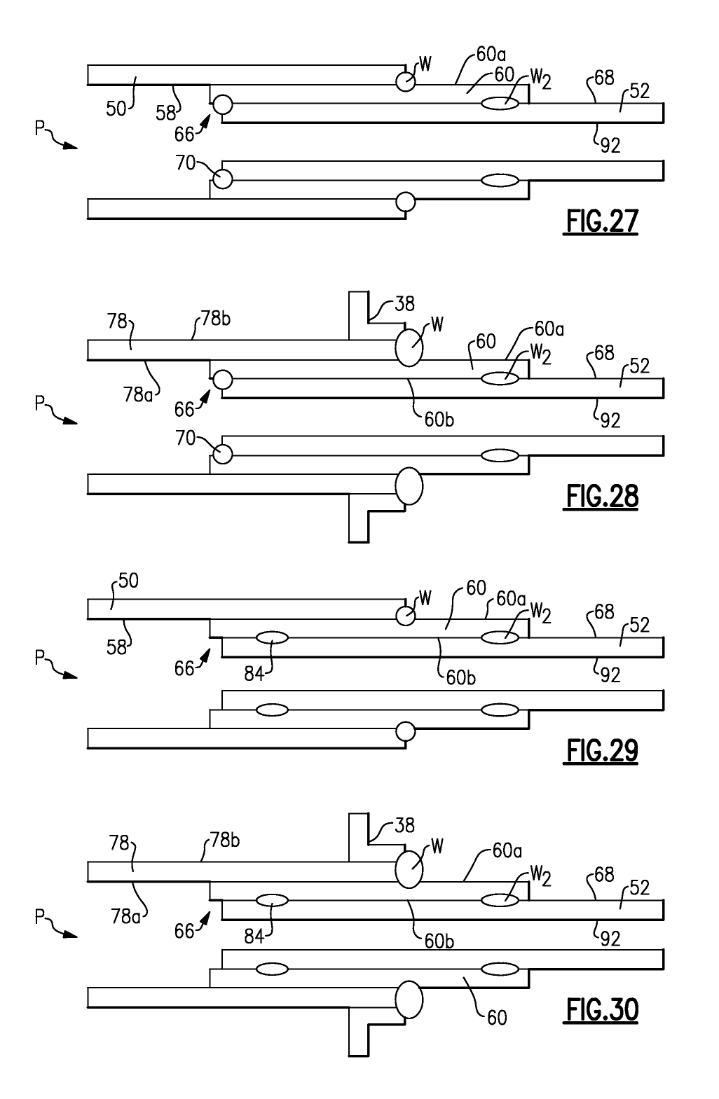

FIG. 28 is similar to FIG. 3 but also includes the second weld W2.

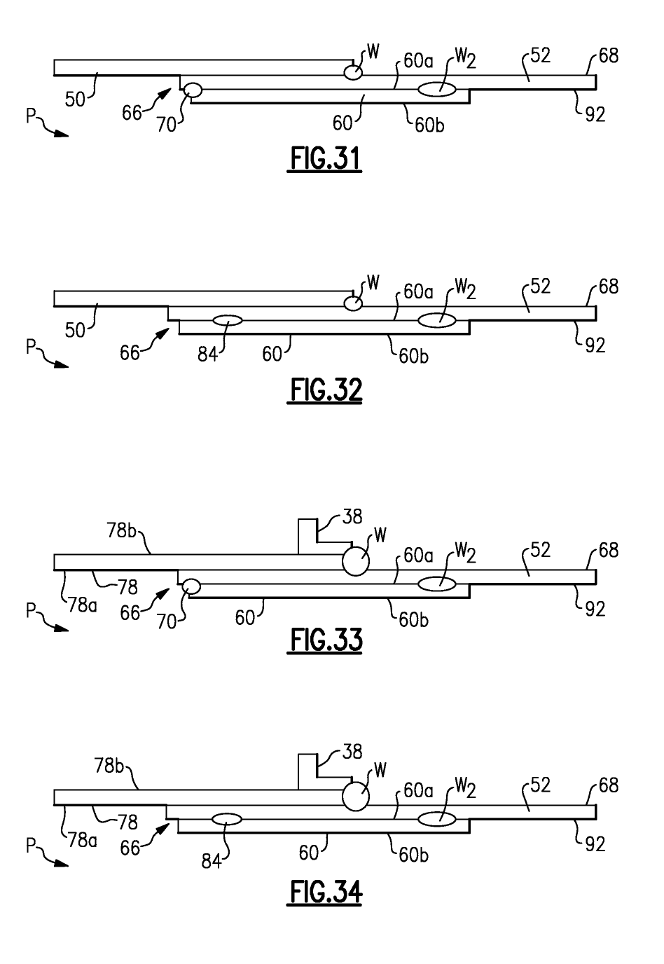

FIG. 29 is similar to FIG. 6 but also includes the second weld W2.

FIG. 30 is similar to FIG. 7 but also includes the second weld W2.

FIG. 31 is similar to FIG. 10 but also includes the second weld W2.

FIG. 32 is similar to FIG. 12 but also includes the second weld W2.

FIG. 33 is similar to FIG. 14 but also includes the second weld W2.

FIG. 34 is similar to FIG. 16 but also includes the second weld W2.

FIG. 35 is similar to FIG. 18 but also includes the second weld W2.

FIG. 36 is similar to FIG. 20 but also includes the second weld W2

FIG. 37 is similar to FIG. 22 but also includes the second weld W2.

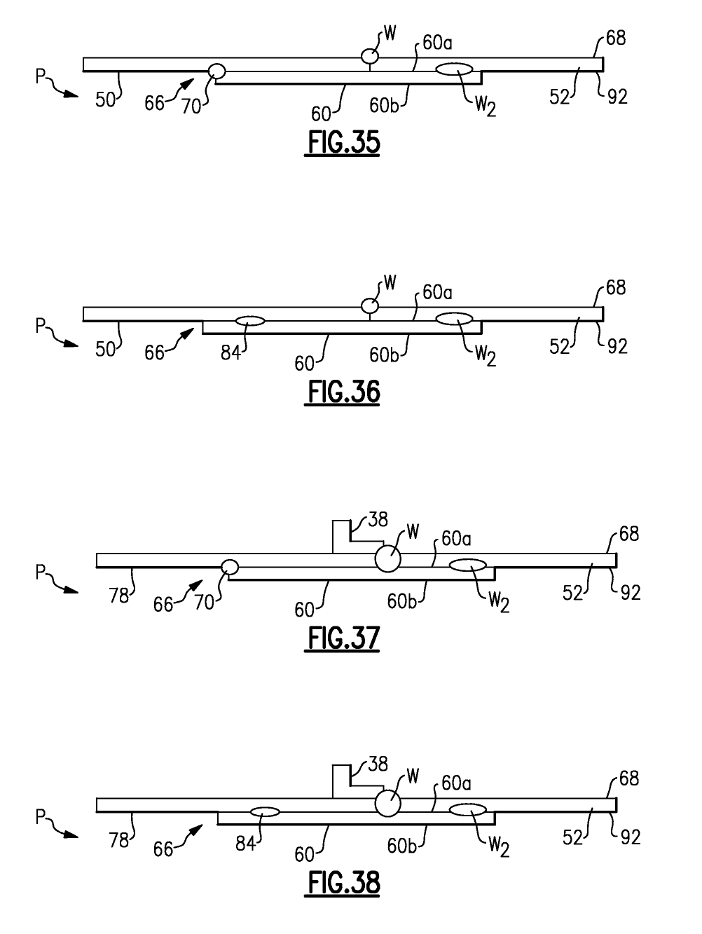

FIG. 38 is similar to FIG. 24 but also includes the second weld W2.

Use of the reinforcement member 44 significantly reduces localized stresses at connection interfaces 42 between adjacent pipes and/or exhaust components. This provides a more robust joint with an overall improved quality perception for the exhaust system 30. Further, as these connection joints have been strengthened, wall thicknesses of the pipes and/or exhaust components can be reduced to provide additional weight and cost savings. Also, due to the use of the reinforcement member 44, there is less concern with weld variability, which further improves overall quality.

FIG. 1 is highly schematic and it should be understood that the exhaust system 30 can include many different combinations of exhaust components 38 and pipes 40 between the engine 34 and the outlet 36. Further, the reinforcement member 44 can be used at each connection interface 42 or only those connection interfaces 42 subjected to the highest stresses as determined by a specific vehicle application. Finally, while welding brazing, and sizing operations are used to secure components together, other types of joining methods could also be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle exhaust system comprising:
a first exhaust component;
a second exhaust component having a first end and a second end, said first end being secured to said first exhaust component at a connection interface; and
a reinforcement member spaced radially inwardly of said first exhaust component at said connection interface, said reinforcement member being associated with said first exhaust component and said first end of said second exhaust component to strengthen said connection interface.

2. The vehicle exhaust system according to claim 1 wherein said first exhaust component comprises a muffler and said second exhaust component comprises an exhaust pipe having said first end received within an opening of said muffler.

3. The vehicle exhaust system according to claim 1 wherein said first exhaust component comprises a first exhaust pipe having a central opening and said second exhaust component comprises a second exhaust pipe with said first end being inserted into said central opening of said first exhaust pipe.

4. The vehicle exhaust system according to claim 1 wherein said reinforcement member comprises a rigid sleeve having an overlapping relationship with each of said first and said second exhaust components, said rigid sleeve having a first sleeve end and a second sleeve end, said first sleeve end being associated with said first end of said second exhaust component and being surrounded by an inner surface of said first exhaust component.

5. The vehicle exhaust system according to claim 1 wherein said reinforcement member is attached to said first end of said second exhaust component by one of welding, brazing, or sizing.

6. The vehicle exhaust system according to claim 1 wherein said reinforcement member is positioned radially between said first exhaust component and said second exhaust component.

7. The vehicle exhaust system according to claim 1 wherein said first end of said second exhaust component is positioned radially between said first exhaust component and said reinforcement member.

8. The vehicle exhaust system according to claim 1 wherein an end face said first end of said second exhaust component is attached to an end face of said first exhaust component at said connection interface, and wherein said reinforcement member has a first reinforcing end surrounded by said first exhaust component and a second reinforcing end surrounded by said first end of said second exhaust component.

9. The vehicle exhaust system according to claim 1 wherein said first exhaust component comprises a muffler having an outer shell portion with an opening and an internal pipe portion extending from said opening into an internal cavity defined by said outer shell portion, and wherein said second exhaust component comprises an exhaust tube inserted into said opening such that said internal pipe portion surrounds said first end.

10. The vehicle exhaust system according to claim 9 wherein said connection interface comprises an interface at said outer shell portion and an end face of said internal pipe.

11. The vehicle exhaust system according to claim 1 wherein said reinforcement member comprises a rigid sleeve having one end welded to said second exhaust component with a first weld and an opposite end welded to said second exhaust component with a second weld.

12. A vehicle exhaust system comprising:
a first exhaust component;
a second exhaust component having a first end and a second end, said first end being surrounded by said first exhaust component;
a reinforcement member in an overlapping relationship with each of said first and said second exhaust components to strengthen a connection between said first and said second exhaust components;
a first connection interface between said first exhaust component and at least one of said reinforcement member and said second exhaust component; and
a second connection interface between said reinforcement member and at least one of said first and said second exhaust components.

13. The vehicle exhaust system according to claim 12 wherein said first connection interface comprises a first weld and said second connection interface comprises one of welding, brazing, or sizing.

14. The vehicle exhaust system according to claim 12 wherein said second connection interface is at one end of said reinforcement member and including a third connection interface between an opposite end of said reinforcement member and said second exhaust component.

15. The vehicle exhaust system according to claim 12 wherein said reinforcement member comprises a rigid sleeve.

16. The vehicle exhaust system according to claim 16 wherein said rigid sleeve is positioned radially inwardly of said first exhaust component and radially outwardly of said second exhaust component.

17. The vehicle exhaust system according to claim 16 wherein said rigid sleeve is positioned radially inwardly of said first exhaust component and said second exhaust component.

18. A method of reinforcing a connection interface within a vehicle exhaust system comprising the steps of:
(a) providing a first exhaust component and a second exhaust component;
(b) securing a first end of the second exhaust component to the first exhaust component at a connection interface;
(c) spacing a reinforcement member radially inwardly of the first exhaust component at the connection interface; and
(d) securing the reinforcement member to at least one of the first exhaust component and the second exhaust component to strengthen the connection interface.

19. The method according to claim 18 including attaching the reinforcement member to the second exhaust component prior to attaching the first and second exhaust components to each other at the connection interface.
